(19) United States
(12) Patent Application Publication
(10) Pub. No.: US 2018/0116128 A1
(43) Pub. Date: May 3, 2018

(54) PLANT GROWING APPARATUS

(71) Applicant: Mark Gin, San Francisco, CA (US)

(72) Inventor: Mark Gin, San Francisco, CA (US)

(21) Appl. No.: 15/802,393

(22) Filed: Nov. 2, 2017

Related U.S. Application Data
(60) Provisional application No. 62/416,361, filed on Nov. 2, 2016.

(51) Int. Cl. A01G 9/02

(52) U.S. Cl. CPC A01G 9/02

(57) ABSTRACT

A plant growing apparatus comprising: a bag member including a bottom wall and at least one side wall; and a composition of soil. Wherein the at least one side wall is connected to and extends upwardly from the bottom wall. Wherein the at least one side wall includes a top portion defining an upper opening of said plant growing apparatus. Wherein the bottom wall and the at least one side wall are formed from a non-rigid flexible material. Wherein the bottom wall and said at least one side wall forms an interior volume. Wherein the composition of soil is located within the interior volume of the bag member.

### CROSS-REFERENCE TO RELATED APPLICATION

The present application is related to and claims priority from prior provisional application Ser. No. 62/416,361, filed Nov. 2, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of growing bags for plants and more specifically relates to a plant growing apparatus structured and arranged for growing and storing a plant, including a composition of premix soil for vegetation of the plant having a storage means is adapted to have a surface material that penetrates air and water within the composition of premix soil.

### 2. Description of the Related Art

Container gardening or pot gardening is the practice of growing plants, including edible plants, exclusively in containers instead of planting them in the ground. A container in gardening is a small, enclosed and usually portable object used for displaying live flowers or plants. It may take the form of a pot, box, tub, pot, basket, tin, barrel or hanging basket.

Pots, traditionally made of terracotta but now more commonly plastic, and window boxes have been the most commonly seen. Small pots are commonly called flowerpots. A plant pot is a container in which flowers and other plants are cultivated and displayed. Historically, and still to a significant extent today, they are made from terracotta. Flowerpots are now often also made from plastic, wood, stone, or sometimes biodegradable material. An example of biodegradable pots are ones made of heavy brown paper, cardboard, or peat moss in which young plants for transplanting are grown. There are often holes in the bottom of pots, to allow excess water to flow out, sometimes to a saucer that is placed under the flowerpot. The plant can use this water with its roots, as needed. Recently, some flowerpots have been made with an automatic watering system, using a reservoir.

In some cases, this method of growing is used for ornamental purposes. This method is also useful in areas where the soil or climate is unsuitable for the plant or crop in question. Using a container is also generally necessary for houseplants. Limited growing space, or growing space that is paved over, can also make this option appealing to the gardener. Additionally, this method is popular for urban gardening on balconies of apartments and condominiums where gardeners lack the access to the ground for a traditional garden

There are many numbers of planting pots available in the market, which has a very prickly structure, subsequently the user needs to be very tidy while planting the plants inside it. Although the user has completed their job, but in case, if the user is required to move the plant with its pot, the movement of the whole structure becomes a chaotic task and also it can be a reason for a number of lesions either to the user or a plant during the movement.

Various attempts have been made to solve the above-mentioned problems such as those found in U.S. Publication Number 20140190076 to Brian Weinzapfel; U.S. Pat. No. 6,016,628 to Ulrich Schlosser; and U.S. Pat. No. 8,826,590 to Cross et al. None of the above inventions and patents, taken either singly or in combination, is seen to describe the invention as claimed.

Ideally, a plant growing apparatus should be user-friendly and safe in-use and, yet should operate reliably and be manufactured at a modest expense. Thus, a need exists for a plant growing apparatus structured and arranged for growing and storing a plant, including a composition of premix soil for vegetation of the plant having a storage means adapted to have a surface material that penetrates air and water within the composition of premix soil and to avoid the above-mentioned problems.

### BRIEF SUMMARY OF THE INVENTION

In view of the foregoing disadvantages inherent in the known growing bags for plants device art, the present invention provides plant growing apparatus. The general purpose of the present invention, which will be described subsequently in greater detail is to provide a plant growing apparatus structured and arranged for growing and storing a plant, including a composition of premix soil for vegetation of the plant having a storage means is adapted to have a surface material that penetrates air and water within the composition of premix soil.

A plant growing apparatus comprising: a bag member including a bottom wall and at least one side wall; and a composition of soil. Wherein the at least one side wall is connected to and extends upwardly from the bottom wall. Wherein the at least one side wall includes a top portion defining an upper opening of said plant growing apparatus. Wherein the bottom wall and the at least one side wall are formed from a non-rigid flexible material. Wherein the bottom wall and said at least one side wall forms an interior volume. Wherein the composition of soil is located within the interior volume of the bag member.

The present invention holds significant improvements and serves as a plant growing apparatus. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Plant Growing Apparatus constructed and operative according to the teachings of the present invention.

FIG. 1 shows a perspective view illustrating a Plant Growing Apparatus according to an embodiment of the present invention.

FIG. 2 is a perspective view illustrating the Plant Growing Apparatus in an in-use condition according to an embodiment of the present invention.

FIG. 3 is a perspective view illustrating a bag member of the Plant Growing Apparatus according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a growing bag for plants and more particularly to a plant growing apparatus structured and arranged for growing and storing a plant, including a composition of premix soil for vegetation of the plant having a storage means is adapted to have a surface material that penetrates air and water within the composition of premix soil

Generally speaking the plant growing bag is generally constructed to contain a predetermined volume of growing medium such as a composition of premix soil with a seed or a small young plant in a predetermined amount to allow plant root growth within the growing apparatus while the remaining portion of the plant extends outside of the growing apparatus.

The plant growing apparatus comprises an opening at the top section of the growing apparatus for implanting the plant and after planting, putting the water and other nutrients in the predetermined interval of time. The plant growing apparatus is made of material selected from a group of, but not limited to, sta-green, premium weed control, or a combination thereof, although other suitable material can also be used by the producer as per their requirement. Further, the shape is, but not limited to, a cylindrical shape and structure of the growing apparatus with a round base at the bottom section of the apparatus and can be just flat rectangular shape with open on the top for soil to pour through.

Once the apparatus is filled with soil, it can stand by itself then it would be more of cylinder shape. The used material is having a permeable surface that allows air and water penetration for healthy soil. Also, the material is enhanced ultraviolet (UV) protection for added durability, if the apparatus is left out in the sun for a longer period of time. The composition of the premix soil is also selected by the producer as per the convenience and adaptability of the vegetating or planting plants and the requirement of the nutrients for the planted and vegetated plant.

The method for the planting apparatus includes that the user needs to be cut a small opening on the top section of the growing apparatus and insert the seed or baby plant in the growing apparatus and add water and other relevant nutrients for the planted plant.

The above-mentioned plant growing apparatus provides a flexibility to users by eliminating the hassles of buying, planting pots, soil, and fertilizer, which is inexpensive, durable and fully effective in accomplishing its intended purposes. The plant growing apparatus has a UV and weather protected surface with a compact base. In addition, the plant growing apparatus with a premix soil composition is simple, lightweight, sturdy and resistant to abrupt weather condition. The user can be easily used the growing apparatus with any size and shape as per their desire.

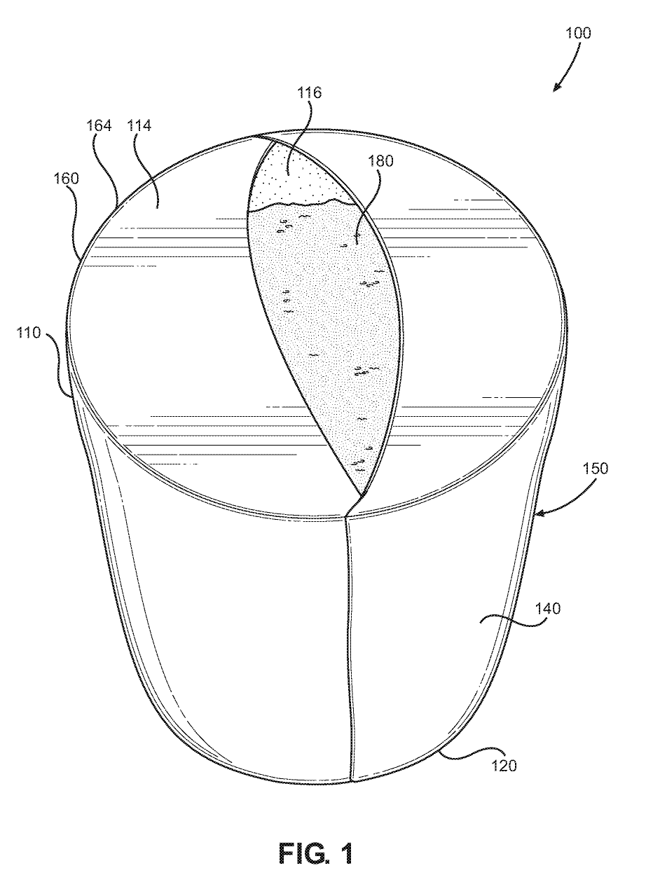

Referring now to FIGS. 1-3, showing perspective views illustrating plant growing apparatus 100 according to an embodiment of the present invention of FIG. 1.

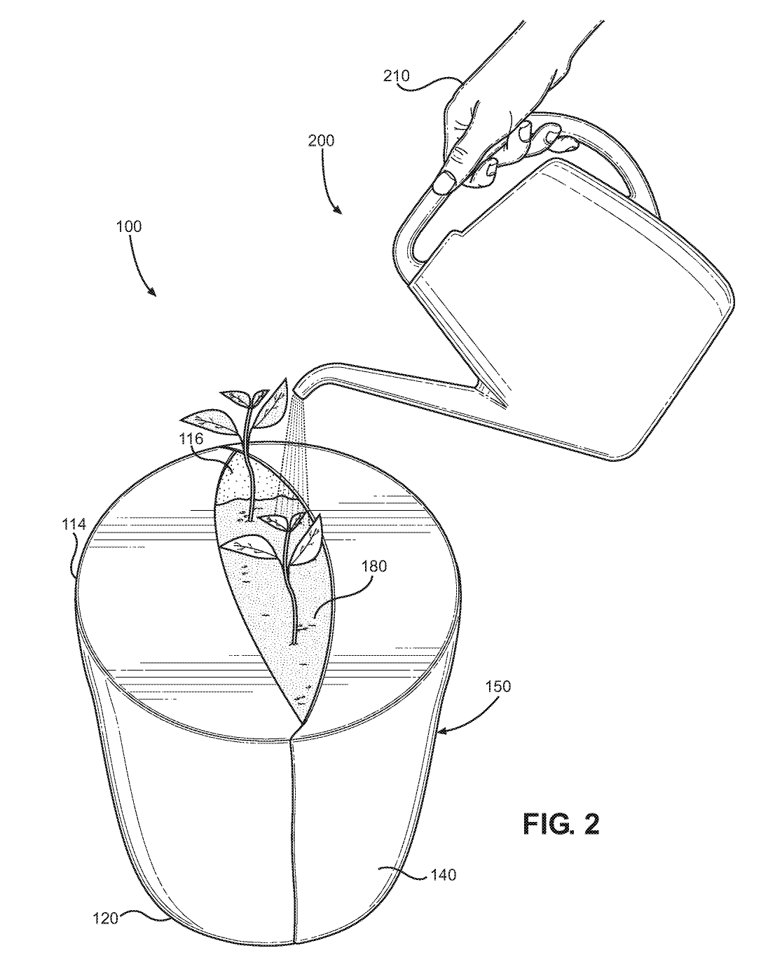

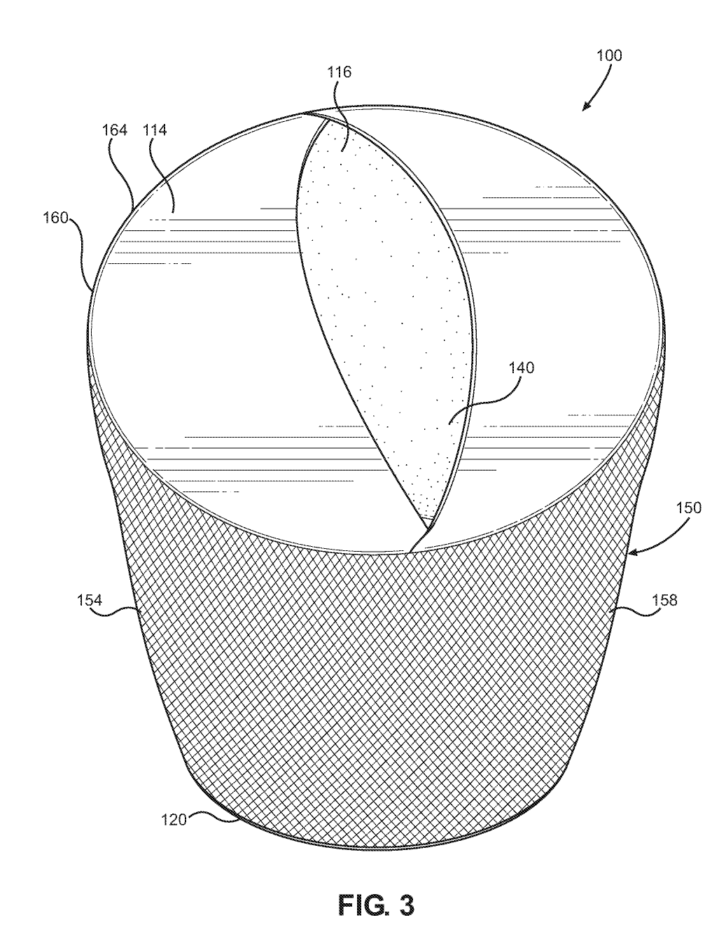

Plant growing apparatus 100 comprising: bag member 110 including bottom wall 120 and at least one side wall 150; and composition of soil 180 as shown in FIG. 1. Wherein at least one side wall 150 is connected to and extends upwardly from bottom wall 120. Wherein at least one side wall 150 includes top portion 160 defining upper opening 164 of plant growing apparatus 100. Wherein at least one side wall 150 is formed having a cylindrical shape. Wherein bottom wall 120 is water permeable as shown in FIG. 3. Wherein bottom wall 120 is formed having a circular shape.

Wherein bottom wall 120 and at least one side wall 150 forms interior volume 140 as shown in FIG. 3. Wherein bag member 110 further includes top wall 114 attached to top portion 160 of at least one side wall 150 and is adapted to cover upper opening 164; wherein top wall 114 is formed from a flexible material; and wherein top wall 114 includes a slit portion 116 formed therein adapted to allow access into and out of interior volume 140. Wherein slit portion 116 extends across a substantial length of top wall 114.

Wherein bottom wall 120 and the at least one side wall 150 are formed from a non-rigid flexible material. Wherein non-rigid flexible material of at least one side wall 150 is water permeable. Wherein the non-rigid flexible material of at least one side wall 150 is capable of blocking ultra-violet light wavelengths. Wherein the non-rigid flexible material of said at least one side wall 150 includes weed killing material 154 embedded therein adapted to mitigate into composition of soil 180 during irrigation by user 210 in-use condition 200 of FIG. 2. Wherein weed killing material 154 is chosen from a group of weed killing material consisting of glyphosate, aminopyralid, clopyralid, dicamba, fluazifop, Imazapic, paraquat, sodium chlorate, vinegar, citrus oil, and monocerin. Wherein the non-rigid flexible material of at least one side wall 150 includes plant feeding material 158 embedded therein adapted to mitigate into composition of soil 180 during irrigation by user 210 as shown in in-use condition 200 of FIG. 2. Wherein plant feeding material 158 is chosen from a group of plant feeding material consisting of nitrogen, phosphorus, potassium, citric acid, and sugar.

Wherein composition of soil 180 is located within interior volume 140 of bag member 140. Wherein composition of soil 180 is formed as a mixture of selected materials chosen from a group of materials consisting of sphagnum peat moss, sand, perlite, composted organic material, loam, top soil, coconut coir, bone meal, limestone, blood meal, worm castings, pumice, nitrogen, phosphorus, ash, potassium, langbeinite, and alfalfa meal.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A plant growing apparatus comprising:
a bag member including:
a bottom wall; and
at least one side wall;
wherein said at least one side wall is connected to and extends upwardly from said bottom wall; and
wherein said at least one side wall includes a top portion defining an upper opening of said plant growing apparatus;
wherein said bottom wall and said at least one side wall are formed from a non-rigid flexible material;
wherein said bottom wall and said at least one side wall forms an interior volume; and
a composition of soil;
wherein said composition of soil is located within said interior volume of said bag member.

2. The plant growing bag of claim 1, wherein said non-rigid flexible material of said at least one side wall is water permeable.

3. The plant growing bag of claim 1, wherein said non-rigid flexible material of said at least one side wall is capable of blocking ultra-violet light wavelengths.

4. The plant growing bag of claim 1, wherein said non-rigid flexible material of said at least one side wall includes a weed killing material embedded therein adapted to mitigate into said composition of soil during irrigation.

5. The plant growing bag of claim 4, wherein said weed killing material is chosen from a group of weed killing material consisting of glyphosate, aminopyralid, clopyralid, dicamba, fluazifop, Imazapic, paraquat, sodium chlorate, vinegar, citrus oil, and monocerin.

6. The plant growing bag of claim 1, wherein said non-rigid flexible material of said at least one side wall includes plant feeding material embedded therein adapted to mitigate into said composition of soil during irrigation.

7. The plant growing bag of claim 4, wherein said plant feeding material is chosen from a group of plant feeding material consisting of nitrogen, phosphorus, potassium, citric acid, and sugar.

8. The plant growing bag of claim 1, wherein said composition of soil is formed as a mixture of selected materials chosen from a group of materials consisting of sphagnum peat moss, sand, perlite, composted organic material, loam, top soil, coconut coir, bone meal, limestone, blood meal, worm castings, pumice, nitrogen, phosphorus, ash, potassium, langbeinite, and alfalfa meal.

9. The plant growing bag of claim 1, wherein said bottom wall is water permeable.

10. The plant growing bag of claim 1, wherein said at least one side wall is formed having a cylindrical shape.

11. The plant growing bag of claim 10, wherein said bottom wall is formed having a circular shape.

12. The plant growing bag of claim 11, wherein said bottom wall is water permeable.

13. The plant growing bag of claim 13, wherein said bag member further includes a top wall attached to said top portion of said at least one side wall and is adapted to cover said upper opening; wherein said top wall is formed from a flexible material; and wherein said top wall includes a slit portion formed therein adapted to allow access into and out of said interior volume.

14. The plant growing bag of claim 1, wherein said slit portion extends across a substantial length of said top wall.
